(19) United States
(12) Patent Application Publication
(10) Pub. No.: US 2015/0261860 A1
(43) Pub. Date: Sep. 17, 2015

(54) PREDICATE EXECUTION IN SHARED DISTRIBUTED COMPUTING ENVIRONMENT

(71) Applicants: Kaushal MITTAL, Dublin, CA (US); Mahendra Chavan, Pune (IN); Kurt Deschler, Dunbarton, NH (US); David Walrath, Boston, MA (US)

(72) Inventors: Kaushal MITTAL, Dublin, CA (US); Mahendra Chavan, Pune (IN); Kurt Deschler, Dunbarton, NH (US); David Walrath, Boston, MA (US)

(21) Appl. No.: 14/205,689

(22) Filed: Mar. 12, 2014

(51) Int. Cl. G06F 17/30

(52) U.S. Cl. CPC G06F 17/30864; G06F 17/30324; G06F 17/30339

(57) ABSTRACT

Disclosed herein are methods for retrieving data from a database. Various embodiments operate by breaking a predicate tree into one or more predicate tree fragments and then executing the various fragments in parallel. The execution of each of the predicate tree fragments results in a bitmap fragment. The bitmap fragments from the execution of the predicate tree fragments can be then combined into a resulting bitmap.

### BACKGROUND

Database commands may contain statements having one or more predicates, or statements that have Boolean results. Consider, for example, the following SQL WHERE statement:

| | |
|---|---|
| FROM | CarTable |
| WHERE | car.color = ‘red’ |
| AND | (car.cylno=6 OR car.year>= 2014) |

The above WHERE statement contains 3 predicates: the first relating to the color of the car being red, the second relating to whether the car has 6 cylinders and the third relating to whether the year of the car is greater than or equal to 2014.

Thus, to execute this WHERE statement, a database system must make at least three evaluations for each record in the database CarTable in order to identify record of cars that are both red and that have either six cylinders or that were made on or after 2014. While this prospect might not be particularly troubling if CarTable is not very large, it could be very taxing on system resources if CarTable (like most modern databases) is large—say on the order of billions of records. Additionally, database commands can result in many more than three predicates being considered.

Given the potential size of modern databases and database commands that contain numerous predicates, it is, therefore, desirable decrease the amount of effort required by system resources to evaluate a database command.

### BRIEF DESCRIPTION OF THE DRAWINGS

The accompanying drawings are incorporated herein and form a part of the specification.

FIG. 1 is a functional block diagram of a distributed computing system according to various embodiments described in this disclosure.

FIG. 2 contains representations of predicate execution according to various embodiments described in this disclosure.

FIG. 3 is a representation of a predicate tree according to various embodiments described in this the disclosure.

FIG. 4 is a functional block diagram depicting the operation of a distributed computing system according to various embodiments described in this disclosure.

FIG. 5 is a flowchart depicting a method of predicate execution according to various embodiments described in this disclosure.

FIG. 6 is a flowchart depicting a method of predicate execution according to various embodiments described in this disclosure.

FIG. 7 is a flowchart depicting a method of predicate execution according to various embodiments described in this disclosure.

FIG. 8 depicts an exemplary distributed computing system according to various embodiments described by this disclosure

FIG. 9 is a functional block diagram depicting a computer system that can be used to implement several features of various embodiments described by this disclosure.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, method and/or computer program product embodiments, and/or combinations and sub-combinations thereof, for executing predicates in database queries.

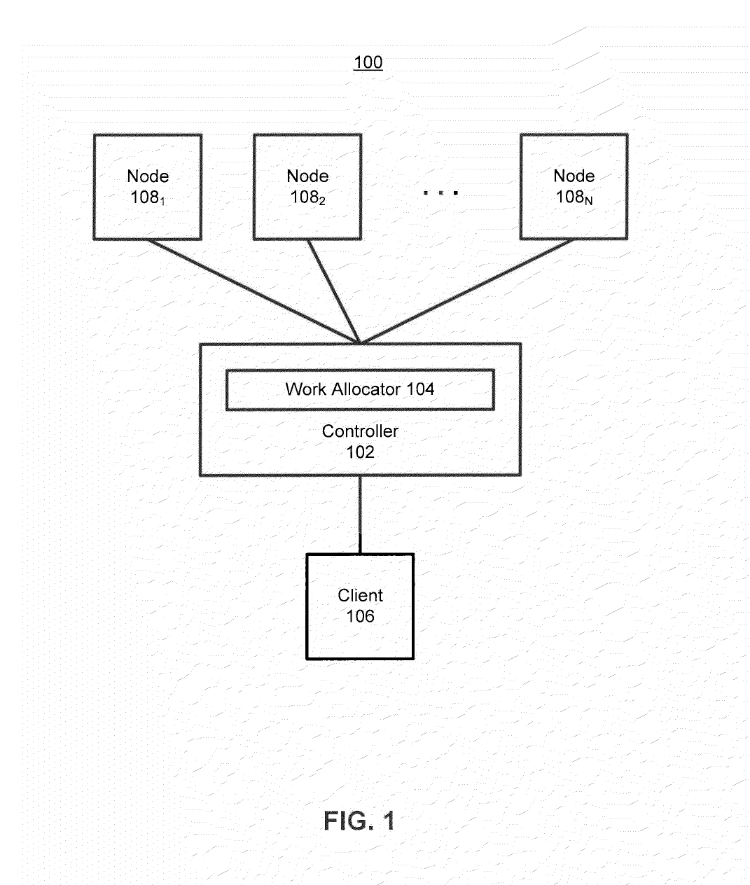

FIG. 1 is a functional block diagram depicting a distributed computer system 100 according to various embodiments. The system 100 may include a controller 102, a work allocator 104, which forms part of a controller 104, a client computer 106 and one or more nodes 108₁, 108₂, . . . 108_{N} (collectively referred to herein as “nodes 108”).

According to various embodiments, each of the controller 102 and the nodes 108 may comprise similar computer systems connected via suitable communications networks. A client computer 106 can communicate with any node 108 in the system and send it a computing task or work assignment (e.g., a database query such as an SQL command). When a client computer 106 sends such a task or work assignment to a particular node, that node then becomes the controller 102 for the purposes of completing the task from the client computer 106.

The work allocator 104 may be responsible for assigning fragments of the task from the client computer 106 to the various nodes 108. For instance, the work allocator might break a task into an equal number of fragments. According to some embodiments, the number of fragments may be correlated to the number of nodes extant in the system 100, but this not need be the case. For instance, FIG. 1 depicts a system 100 with N nodes. Accordingly, the work allocator 104 break a task into N fragments to be sent to the various nodes 108. That is, the work allocator 104 might send a first fragment to node 108₁, a second fragment to node 108₂, the Nth fragment to 108_{N}, and so on.

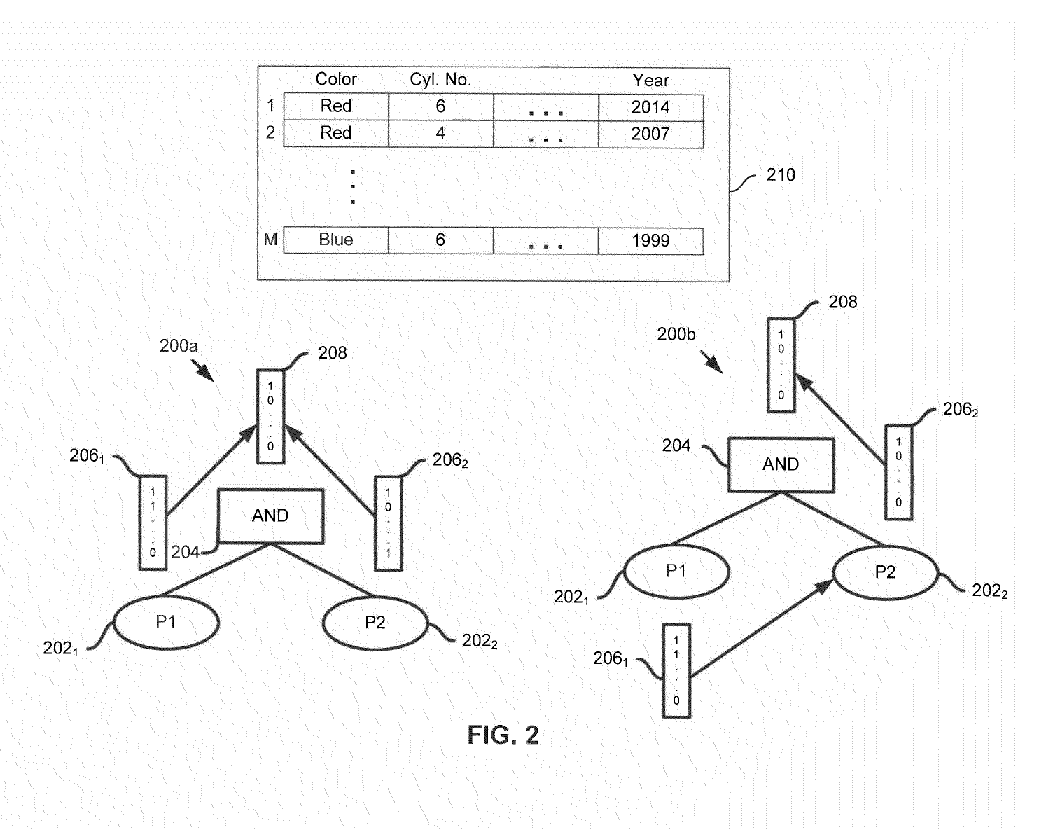

FIG. 2 depicts several concepts relating to the processing of database queries—particularly those that use multiple predicates. Consider a database table 210, that is similar to the database CarTable described in the background section, supra. As shown, the database table 210 contains M records (i.e., records 1, 2, . . . M) that each have a number of corresponding columns. By way of example, FIG. 2 depicts the database table 210 as having the columns “Color”, “Cyl. No.”, and “Year.” Assume, now, that a client computer 106 sent a query for database table 210 that required determining which of the records in database table 210 had “Red” in the “Color” column and “6” in the “Cyl. No.” column. For instance an SQL statement such as:
WHERE car.color=‘red’ AND car.cylno=6

This is a query with simple two predicates, or statements with possible true/false values. The first predicate (car.color=‘red’), P1, is true when the “color” column in a particular record is red and the second predicate (car.cylno=6), P2, is true when the “Cyl.No.” column equals 6. One way to handle such a request is to scan the database table 210 and return a bitmap where the predicate at issue is true. A bitmap may comprise an array of bits where each bit of the bitmap is associated with a row of the database table 210. The individual bits of the bitmap are toggled between ‘0’ and ‘1’ to indicate whether or not a particular row or record satisfies the condition associated with the predicate at issue. For instance, after executing the first predicate P1, the a bitmap comprising {1, 1, . . . , 0} might be returned because rows 1 and 2 of database table 210 have “red” as a value in the color column and row “M” does not. Similarly, after executing the second predicate P2, a bitmap comprising {1, 0, . . . , 1} might be returned because P2 is true for rows 1 and M, which each have “6” as the value in the Cyl.No. column.

The WHERE statement described above, however, is more complex than the simple predicates P1 and P2 individually. Instead, the WHERE statement requires combining the results of the execution of the results the predicates P1 and P2 individually. One way of doing this is the way shown in graph 200a.

Graph 200a depicts a predicate tree comprising leaves 202₁ and 202₂ that are associated with predicates P1 and P2, respectively. Parent node 204 contains the conjunction AND in this case to indicate that P1 and P2 are connected by an AND operator. In graph 200a, each of the predicates P1 and P2 is executed with respect to the database table 210 to produce bitmaps 206₁ and 206₂, associated with P1 and P2, respectively. Bitmaps 206₁ and 206₂ can then be combined using the appropriate AND operation to arrive at the result bitmap 208. As indicated, the result bitmap 208 has a “1” bit only where both P1 and P2 are true (i.e., row 1 in this example) and a “0” value where either P1, P2, or both are not true.

Graph 200b is similar to graph 200a, but depicts a slightly different operation with some efficiency advantages. In the process outlined in graph 200a, each of the predicates P1 and P2 had to be evaluated with respect to each row of the database table 210. However, since combined predicate P1 AND P2 requires both simple predicates to be true, this is not, strictly speaking, necessary. Instead predicate P1 can be executed to produce bitmap 206₁ as before. However, bitmap 206₁ can be used as an input to the execution of P2 as a way of limiting which of the rows of database table 210 are evaluated for P2. That is, P2 needs only to be evaluated with respect to those rows that are true or have a “1” value in 206₁. Thus, the execution of P2 will only evaluate the rows that bitmap 206₁ has indicated are true for P1. This results in avoiding the evaluation of unnecessary rows of database table 210 thereby saving computational resources and time.

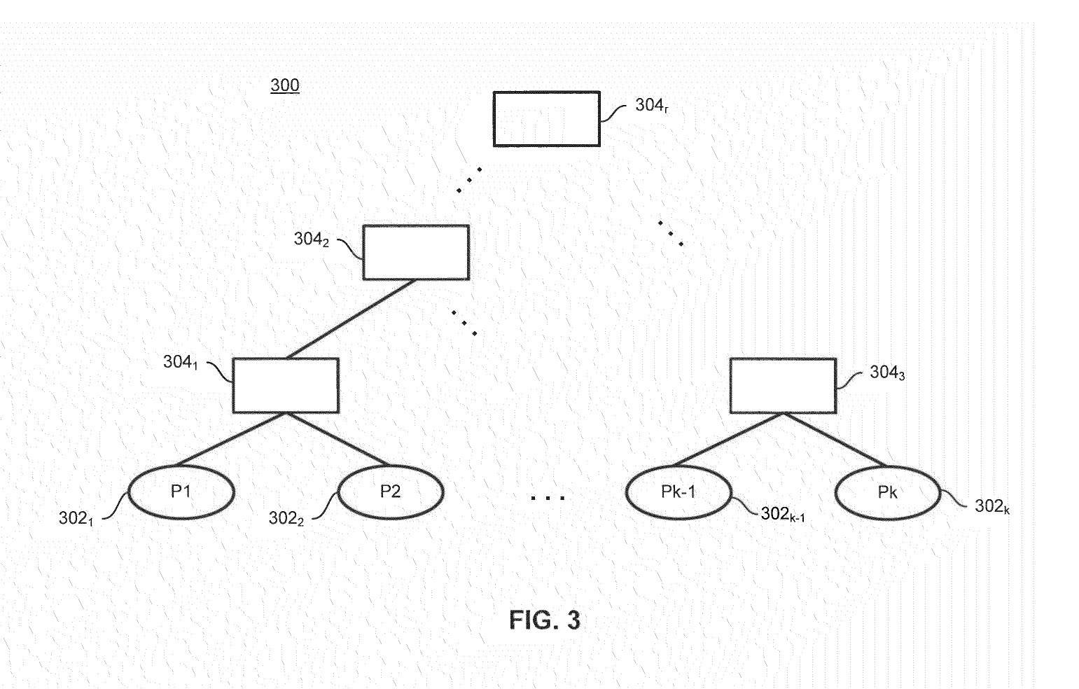

So far, the concepts of predicates and database commands have been described with respect to relatively simple commands that result in small predicate trees (e.g., the trees depicted in graphs 200a and 200b). However, it should be understood that predicate trees can be arbitrarily large and, therefore, arbitrarily complex. FIG. 3 depicts one such predicate tree 300.

As shown in FIG. 3, predicate tree 300 comprises a number of different leaf nodes 302₁, 302₂, . . . , 302ₖ₋₁, and 302ₖ (collectively referred to as “leaf nodes 302”) that each have an associated predicate. Additionally, each of the leaf nodes 302 has an associated parent node (e.g., nodes 304₁ and 304₃) and an arbitrary number of additional non-direct parent nodes (e.g., node 304₂) culminating in a root node 304₁. The various parent nodes (collectively referred to as “parent nodes 304”) can each be associated with conjunctive (e.g., “AND”) or disjunctive (e.g., “OR”) operators that logically link the predicates associated with the leaf nodes 302.

Even using the efficient method depicted by graph 200b, there are inefficiencies in the processes of executing predicates and predicate trees outlined above in a distributed computing environment. A way of performing such distributed computing of predicates or predicate trees is to distribute each predicate for execution to the various nodes 108. Each computing nodes will then execute its work unit and generate a bitmap (such as bitmap 208) corresponding to the work unit. Furthermore, each of the nodes 108 might itself employ several threads to execute sub-work units and each of these threads might itself require generation of a bitmap. Merging all of the bitmaps into a single result bitmap can result in a significant bottleneck. Indeed, a system that has to execute “n” predicates on “m” nodes that each have “t” threads, would require reading and writing n*m*t bitmaps. A better way, in some instances, may be to reduce the number of bitmaps that need to be read and written.

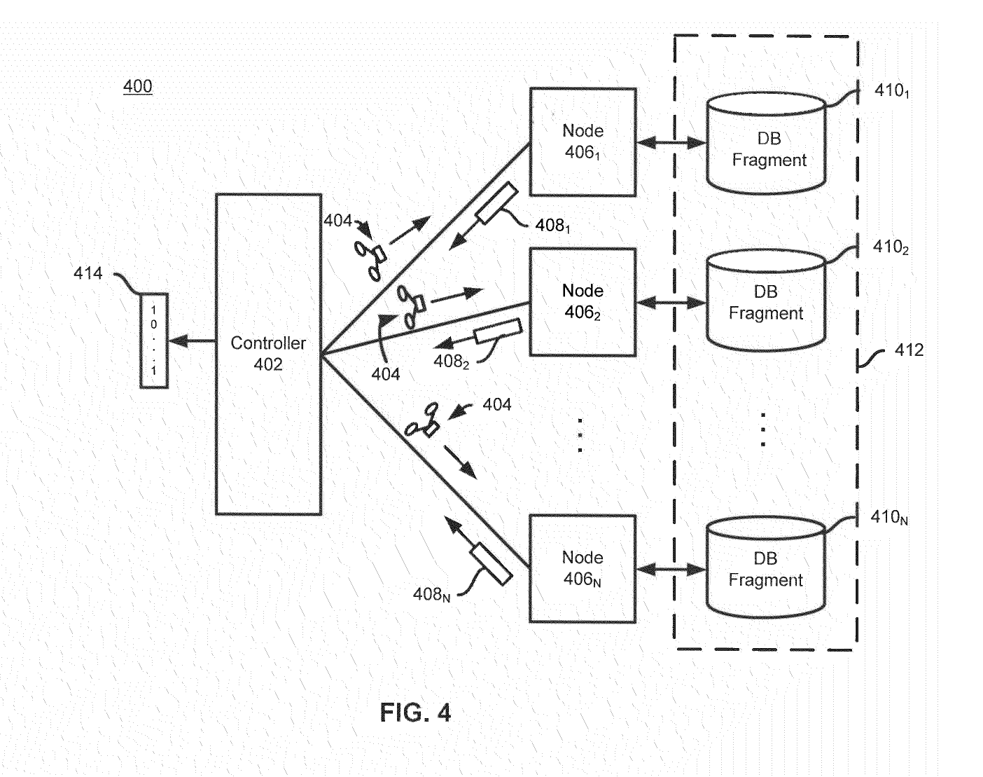

One way of reducing the number of bitmaps that have to be read and written in a given system is to distribute predicate trees as work units to the various nodes of a system rather than individual predicates. Such a scenario is depicted in FIG. 4.

FIG. 4 is an alternate depiction of a distributed computer system 400 similar to the computer system 100 depicted in FIG. 1 As shown, the system 400 contains a controller 402 and a number of computing nodes 406₁, 406₂, and 406_{N} (collectively “nodes 406”) that are communicatively coupled to the controller 402. According to various embodiments, the controller may comprise a computer system and be similar or identical to the computing nodes 406 from a hardware perspective. Indeed, the controller 402 may simply be a computing node to which a database query was directed by a client computer (e.g., client computer 106) thereby making it the controller 402 for the purposes of that query.

According to some embodiments, each of the nodes 406 may be responsible for a particular fragment 410₁, 410₂, . . . 410_{N} (collectively “database fragments 410”) associated with a complete database 412. For instance, if database 412 comprises “m” rows and there are “n” nodes, then each of the fragments 410 might comprise m/n rows. Database fragment 412₁ could then be associated with rows 1 to m/n, database fragment 410₂ could be associated with rows (m/n)+1 to 2m/n, and so on.

Instead of executing the various predicates individually in a distributed fashion, the system 400 is configured to combine multiple predicates into a single execution fragment for distributed execution by the nodes 406. In some instances, an entire predicate tree (e.g., tree 300) may be distributed at once for parallel execution to the various nodes 406. However, it is also possible, according to various embodiments, for only some portions of predicate tree 300 to be combined and for the remaining predicates to be sequentially processed.

This approach has several advantages. First, it avoids wasteful result aggregation at the end of each predicate execution. Second, it avoids the serial execution of predicates one after another and, therefore, reduces the distribution overhead. Third, negation and null folding operations can be distributed both in parallel and in a distributed fashion. Fourth, the cost based approach allows each predicate to use the optimal method of execution (e.g., serial or parallel distribution) using the best semantic work partitioning method possible for the predicate while at the same time allowing for the combination of predicates with the same semantic partitioning method irrespective of the individual positions of the various predicates in the predicate tree.

In operation, controller 402 may be responsible for generating a predicate combination 404. According to various embodiments, the predicate combination 404 may comprise an entire predicate tree 300, or may be a subset of the tree 300. For instance the controller 402 may evaluate each of the predicates in a given predicate tree 300 and determine which of them to combine into a predicate combination 404 and which predicates not to combine. According to various embodiments, the predicate combination may comprise any suitable data structure. For instance, in some embodiments, the predicate combination 404 may take the form of a predicate tree.

Once the controller 402 has generated an appropriate predicate combination 404, it can distribute the predicate combination 404 to the various nodes 406, as shown in FIG. 4. Each of the nodes 406 can then execute the predicate combination 404 with respect to its associated database fragment 410. For instance, node 406₁ will execute predicate combination 404 with respect to only the rows associated with its database fragment 410₁. The same is true for the other nodes 406.

After each node 406 executes the predicate combination 404 with respect to its database fragment 401, it can send back a result fragment (e.g., 408₁, 408₂, . . . , 408_{N}—collectively referred to as “result fragments 408”) to the controller 402. These result fragments may, for instance, comprise bitmaps or partial bitmaps for the rows associated with the database fragments 410 associated with each of the nodes 406.

The controller 402 may combine the result fragments 408 can then be combined into a single result 414. According to various embodiments, the result 414 may comprise a bitmap of the database 412 that has the combined results of the execution of all of the nodes 406 on the predicate combination.

As a direct consequence of per-work-unit execution of predicates (i.e., execution of a predicate combination 404 versus the execution of the individual predicates), there are benefits in other aspects of processing a database command including short circuiting of predicates, negation of predicates, null handling etc.

For instance, in a conjunctive tree (e.g., the simple conjunctive trees depicted in graphs 200a and 200b from FIG. 2), if a condition on the left (i.e., P1) of a conjunct 204 evaluates to no results then there is no need to evaluate the conditions on the right side (e.g., P2) of the conjunct 204. As a consequence of the per-work-unit execution model, such short circuiting in a conjunctive tree can happen more often on per-work-unit basis e.g. In a predicate tree: (A AND B), if A results into empty result bitmaps for 5 out of 10 work units then we avoid executing predicate B for these 5 work units. For instance, referring to FIG. 4, the P1 might be entirely null values for database fragments 410 associated with several of the nodes 406. Thus, if the predicate fragment comprised, for instance, the conjunctive trees depicted in graphs 200a and 200b, then P2 would not have to be executed for any of those nodes and a result fragment 208 could be quickly and cheaply returned to the controller 402.

By contrast, individual execution of each predicate individually would require executing predicate B (P2) after executing entire predicate A (P1), since A's overall result 214 will have some rows qualified (i.e., some non-zero rows). Thus, when the predicates are individually executed, it is necessary to execute predicate B and this short circuiting would not be possible there. Thus, short circuiting becomes more efficient at the work-unit level that improves the performance in many cases, especially when the conditions in a conjunctive tree have less correlation.

If a predicate is a negated predicate then we first used to execute the predicate in parallel and then do the negation of its result bitmap serially to output the final result. As a consequence of parallel execution of the entire predicate tree by several threads on per-work-unit basis, such negation happens for a negated predicate for each work-unit in parallel. Thus the negation operation went parallel with this approach.

The same holds true when a predicate is supposed to include NULL values in its result.

Earlier, we used to merge a bitmap representing NULL values with the result bitmap of the predicate serially to generate the final result of the predicate. As a consequence of per-work-unit model, this NULL folding happens on per-work-unit level in parallel.

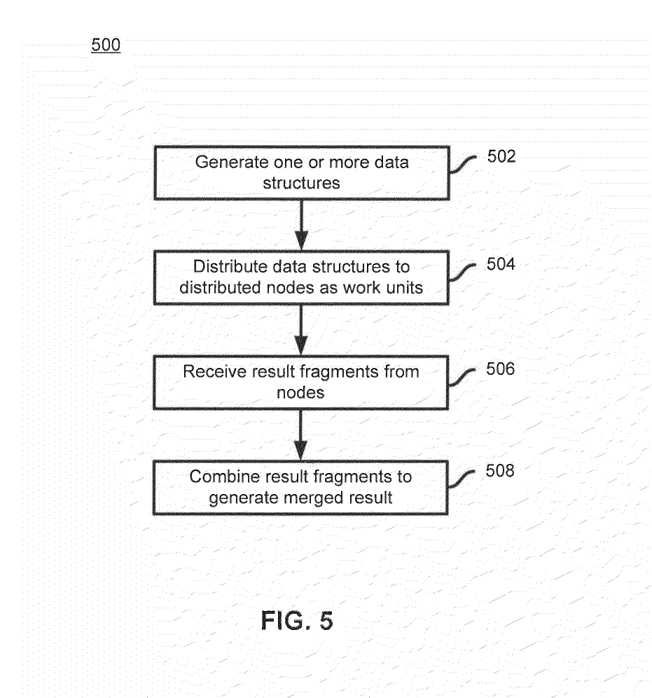

FIG. 5 is a flowchart depicting a method 500 of executing predicates according to various embodiments. For the sake of clarity, FIG. 5 will be described with respect to FIGS. 1-4, but it should be understood that the method 500 described is not meant to be limited to the particular embodiments shown in FIGS. 1-4.

The method 500 begins at step 502 by generating one or more data structures. In some embodiments, step 502 may be performed by the controller 402. For instance, the controller 402 may evaluate each of a number of predicates (e.g., the predicates in predicate tree 300) to be executed and determine which of them can be combined into a predicate combination 404 and which of the predicates cannot be combined. The controller 402 can then generated a data structure for the predicate combination 404 comprising those predicates that can be combined.

At step 504, the generated data structures (e.g., predicate combination 404) can be distributed to the various nodes 406 as work units according to the method 500. Each of the nodes 406 may be responsible for executing the generated data structure such as the predicate combination 404 on its own associated data fragment 410. According to some embodiments, the controller 402 may determine which node 406 is associated with which database fragment 410, however it is also possible to randomly assign nodes to particular database fragments 410.

At step 506, the controller 402 can receive result fragments 408 from each of the nodes 406. According to various embodiments, the result fragments 408 may comprise bitmaps or partial bitmaps for the rows associated with the database fragments 410 associated with each of the nodes 406.

At step 508, the controller 402 can combine the various result fragments 408 into a merged result 414. According to various embodiments, the result 414 may comprise a bitmap of the database 412 that has the combined results of the execution of all of the nodes 406 on the predicate combination.

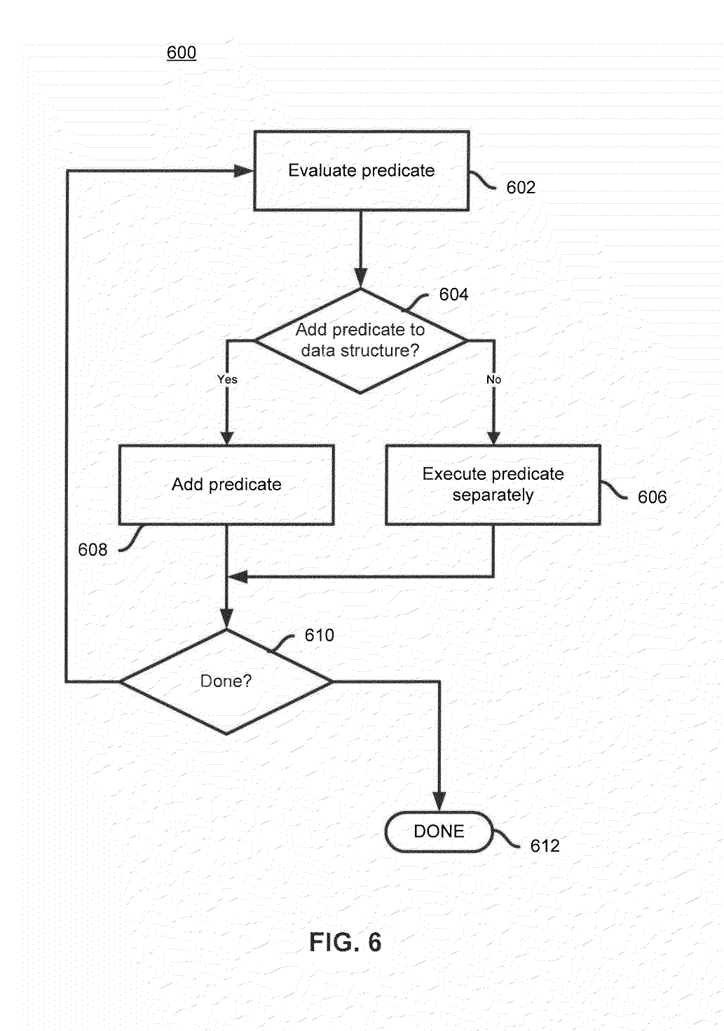

FIG. 6 depicts a method 600 of generating a data structure containing one or more predicates according to various embodiments. For the sake of clarity, FIG. 6 will be described with respect to FIGS. 1-4, but it should be understood that the method 600 described is not meant to be limited to the particular embodiments shown in FIGS. 1-4.

As shown in FIG. 6, method 600 begins at step 602 where a predicate (e.g., P1, P2, etc.) is evaluated to determine whether it is combinable with other predicates in a predicate combination 404. For instance the controller 402 may evaluate each of the predicates in a given predicate tree 300 and determine which of them to combine into a predicate combination 404 and which predicates not to combine.

At step 604, the method 600 determines whether the evaluation from step 602 determined that the predicate should be added to a combined data structure such as predicate combination 404. If so, then the predicate can be added to the predicate combination at step 608. According to various embodiments, the predicate combination 404 may comprise any suitable data structure. For instance, in some embodiments, the predicate combination 404 may take the form of a predicate tree.

At step 610, the method 600 determines whether all it is finished evaluating predicates. If not, then the method loops back to step 602 where the next predicate is evaluated. If so, then the method 600 finishes at step 612.

If at step 604, the method determines that a predicate should not be added to the data structure such as the predicate combination 404, then the predicate is executed separately at step 606. In some instances, the predicate can be identified as a predicate to be executed before or after the predicate combination 404, however, it is also possible to allow the non-combined predicates to execute arbitrarily.

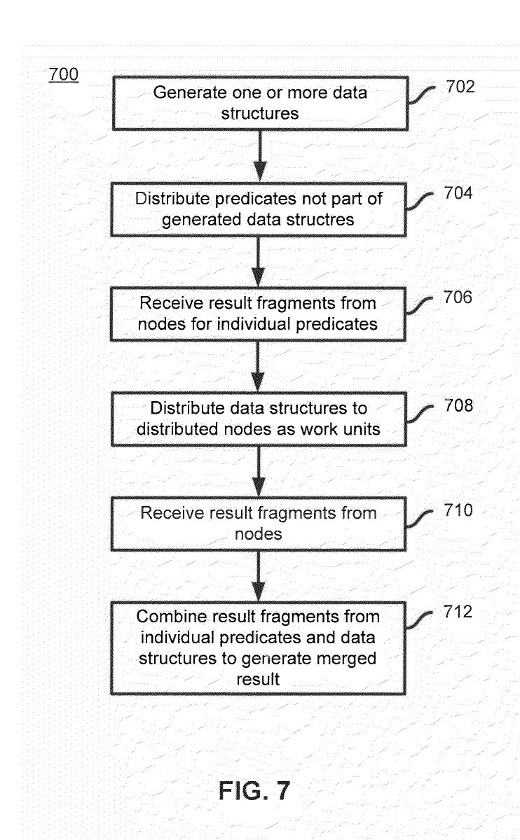

FIG. 7 is a flowchart depicting a method 700 of executing predicates according to various embodiments. For the sake of clarity, FIG. 7 will be described with respect to FIGS. 1-4, but it should be understood that the method 700 described is not meant to be limited to the particular embodiments shown in FIGS. 1-4.

The method 700 begins at step 702 by generating one or more data structures. In some embodiments, step 702 may be performed by the controller 402. For instance, the controller 402 may evaluate each of a number of predicates (e.g., the predicates in predicate tree 300) to be executed and determine which of them can be combined into a predicate combination 404 and which of the predicates cannot be combined. The controller 402 can then generated a data structure for the predicate combination 404 comprising those predicates that can be combined.

At step 704, the controller 402 can distribute the predicates that have not been included in the one or more data structures such as predicate combination 404 to the various nodes 406 for individual serial execution by those nodes 406. That is, each of the nodes 406 can execute the individual predicate on its associated database fragment 410.

At step 706, the controller 402 can receive result fragments 208 for the individually executed predicate or predicates. The result fragments 408 may comprise bitmaps or partial bitmaps for the rows associated with the database fragments 410 associated with each of the nodes 406.

At step 708, the generated data structures (e.g., predicate combination 404) can be distributed to the various nodes 406 for execution on work units according to the method 500. According to various embodiments, the data structures may comprise predicate fragments, which each are a conjunction and/or disjunction of multiple predicates or a single predicate. Each of the nodes 406 may be responsible for executing the generated data structure such as the predicate combination 404 on its own associated data fragment 410. According to some embodiments, the controller 402 may determine which node 406 is associated with which database fragment 410, however it is also possible to randomly assign nodes to particular data fragments 410.

At step 710, the controller 402 can receive result fragments 408 from each of the nodes 406. According to various embodiments, the result fragments 408 may comprise bitmaps or partial bitmaps for the rows associated with the database fragments 410 associated with each of the nodes 406.

At step 712, the controller 402 can combine the various result fragments 408 into a merged result 414. According to various embodiments, the result 414 may comprise a bitmap of the database 412 that has the combined results of the execution of all of the nodes 406 on the predicate combination.

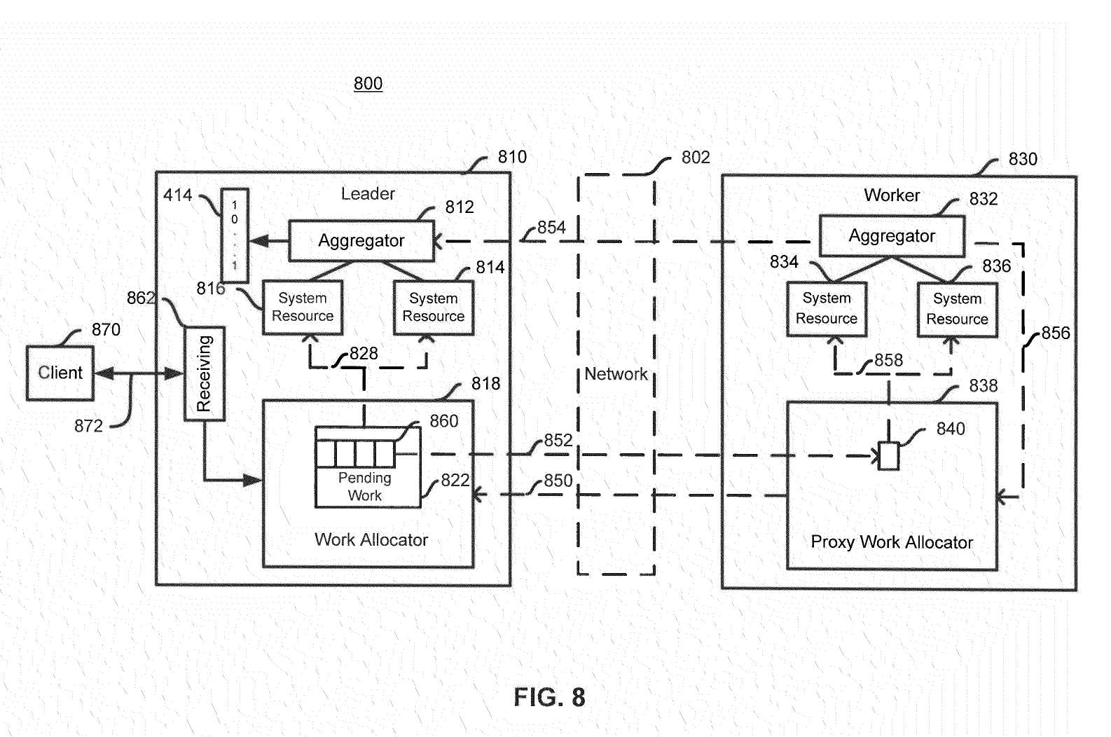

FIG. 8 depicts an exemplary distributed computing system 800 capable of performing various embodiments described above. For simplicity's sake, the distributed computing system 800 is depicted as having two nodes: a leader node 810 (e.g., controller node 102) and a worker node 830 (e.g., any one of nodes 108). Each of the nodes 810 and 830 may comprise essentially the same hardware according to various embodiments, but can also comprise different elements and/or be organized with different functional blocks.

As shown in FIG. 8, the leader node can include an aggregator 812, a work allocator 818, one or more system resources 814 and 816, a pending work queue 818, and an interface/receiving module 862.

According to embodiments of the invention, the leader node 810 receives a work assignment from the client 870 via communications channel 872 at the interface/receiver module 862. The interface/receiver module 862 can then communicate the work assignment to the work allocator 818, which can be tasked with dividing the work assignment into multiple work units for distribution to the various worker nodes 830. The pending work queue 822 can contain a queue of work units that have yet to be assigned to a particular worker node. Additionally, the work allocator may keep track of which work units remain unassigned, which work units have been assigned, which work units are completed, and which work units have failed according to embodiments of the invention.

The leader node also includes system resources 814 and 816 (each comprising, for instance, one or more threads and/or hardware components such as processors and circuits) to which various work units may be assigned if deemed appropriate by the work allocator 818. For instance, the work allocator 818 can assign a work unit 860 to a system resource 813 or 816 by sending the appropriate message 828. The aggregator 812 receives the results of the completed work units from the various worker nodes 830 and from the leader node's own system resources 814 and 816 and aggregates them together. Additionally, the aggregator 812 can indicate to the work allocator 818 when it receives results for the various work units that have been assigned.

A worker node 830 may contain a proxy work allocator 838 to manage its assigned work unit 840, system resources 834 and 836 and an aggregator 832 according to embodiments of the invention. According to embodiments, the proxy work allocator 838 can indicate to the leader node's work allocator 818 that it is capable of accepting a work unit 840 by sending a message 850 via the network 802. When the leader work allocator 818 receives a message from proxy work allocator 838 that the worker node 830 is ready to receive a work unit, it sends a message 852 back with a work unit 840 for execution. Additionally, the work allocator may store identifying information relating to the assigned work unit 840. According to embodiments of the invention, the identifying information may include a unique identifier for the work unit, an identifier to identify the worker node to which the work unit 840 has been assigned, a time stamp indicating the time at which the work unit was assigned, and links to information about all of the other work units that have been assigned to the worker node 830. According to some embodiments, the leader work allocator 818 may send a single work unit 840 upon receiving a request message 850, however it is also possible for the work allocator 818 to send multiple work units at a time to the worker node 830 according to some embodiments.

When worker node 830 receives a work unit 840, the proxy work allocator assigns it to an appropriate system resource 836 by sending an appropriate message 858. For instance, if the proxy work allocator 838 sends the work unit 840 to system resource 834 for execution, then system resource 834 can execute the work unit and send the results of the work unit to the aggregator 832. The aggregator 832, upon receipt of the completed results of the execution of the work unit 840, can send a message 856 to the proxy work allocator 838 indicating that the work unit 840 has been successfully completed. The proxy work allocator 838 can then send another message 850 to the leader node 810 indicating that it can receive another work unit according to embodiments of the invention.

The worker node aggregator 832 can, when it receives results from an executed work unit 840, send the results to leader aggregator 812 via message 854 according to embodiments of the invention. However, according to some embodiments of the invention, worker aggregator 832 aggregates the results of several completed work units and sends a message 854 containing all of the several results at once to the leader aggregator 812. According to some embodiments, the worker aggregator can send the message periodically after a predetermined amount of time, once a certain number work units have been completed, or after the aggregated results reach a pre-determined size.

According to embodiments of the invention, the worker node can determine that it has experienced a re-distribution condition (e.g., a failure to successfully execute the work unit) with respect to a work unit 840 that it has been assigned. For instance, the proxy work allocator 838 could determine that a predetermined amount of time has elapsed since it assigned a work unit to a system resource 834 and it has yet to receive a message 856 indicating receive of results of the execution of the work unit 840 by system resource 834. According to embodiments of the invention, when the worker node 830 has detected such a re-distribution condition the worker node 830 can send a message to the leader 810 with the completed results it has aggregated so far.

When leader work aggregator 812 receives completed results from assigned work units, it can combine them with previously received results to arrive at a combined result, such as result 414, described above. Once the work aggregator does this, the origin of received results will not be distinguishable according to embodiments of the invention.

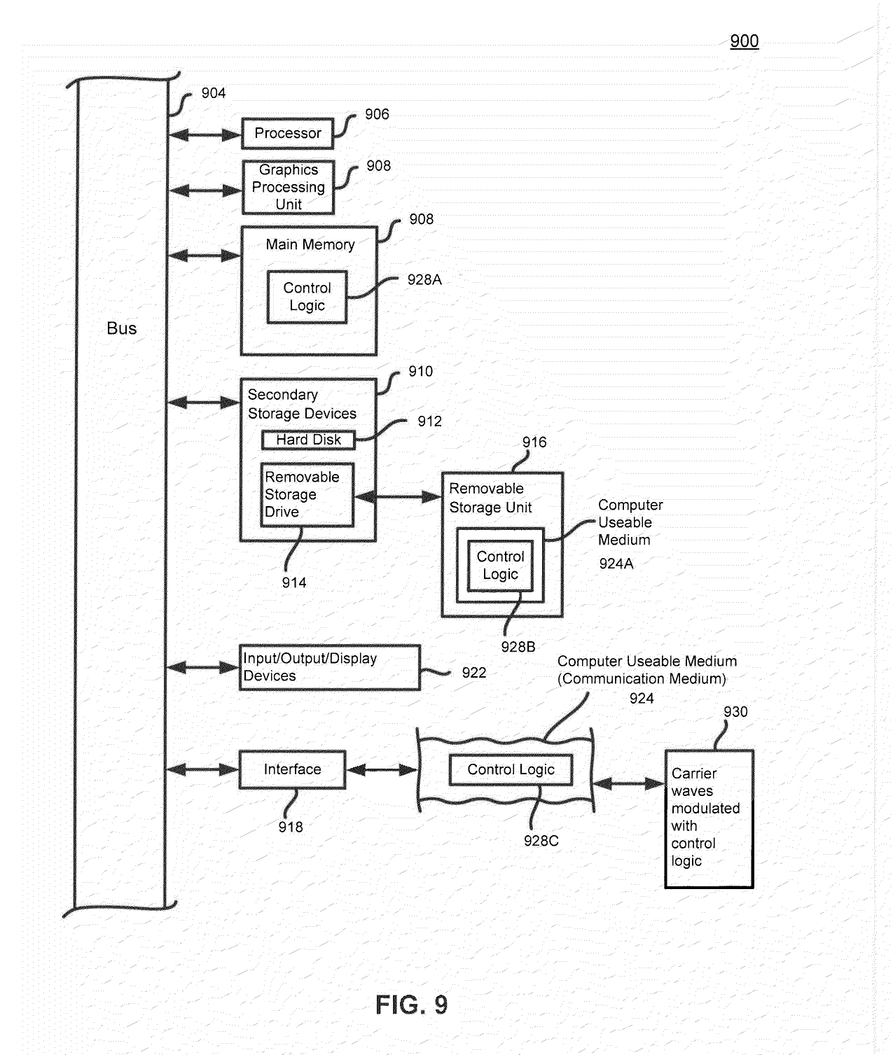

Various embodiments can be implemented, for example, using one or more well-known computer systems, such as computer system 900 shown in FIG. 9. For instance, each node (e.g., controller 104, nodes 108, leader node 810, and worker nodes 830) can be implemented using one or more iterations of computer system 900 according to various embodiments of the disclosure. Computer system 900 can be any well-known computer capable of performing the functions described herein, such as computers available from International Business Machines, Apple, Sun, HP, Dell, Sony, Toshiba, etc.

Computer system 900 includes one or more processors (also called central processing units, or CPUs), such as a processor 904. Processor 904 is connected to a communication infrastructure or bus 906.

Computer system 900 also includes user input/output device(s) 903, such as monitors, keyboards, pointing devices, etc., which communicate with communication infrastructure 1006 through user input/output interface(s) 902.

Computer system 900 also includes a main or primary memory 908, such as random access memory (RAM). Main memory 908 may include one or more levels of cache. Main memory 908 has stored therein control logic (i.e., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 includes a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 reads from and/or writes to removable storage unit 918 in a well-known manner.

According to an exemplary embodiment, secondary memory 910 may include other means, instrumentalities or other approaches for allowing computer programs and/or other instructions and/or data to be accessed by computer system 900. Such means, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 enables computer system 900 to communicate and interact with any combination of remote devices, remote networks, remote entities, etc. (individually and collectively referenced by reference number 1028). For example, communication interface 924 may allow computer system 900 to communicate with remote devices 928 over communications path 926, which may be wired and/or wireless, and which may include any combination of LANs, WANs, the Internet, etc. Control logic and/or data may be transmitted to and from computer system 900 via communication path 926.

In an embodiment, a tangible apparatus or article of manufacture comprising a tangible and/or non-transitory computer useable or readable medium having control logic (software) stored thereon is also referred to herein as a computer program product or program storage device. This includes, but is not limited to, computer system 900, main memory 908, secondary memory 910, and removable storage units 918 and 922, as well as tangible articles of manufacture embodying any combination of the foregoing. Such control logic, when executed by one or more data processing devices (such as computer system 900), causes such data processing devices to operate as described herein.

Based on the teachings contained in this disclosure, it will be apparent to persons skilled in the relevant art(s) how to make and use the embodiments using data processing devices, computer systems and/or computer architectures other than that shown in FIG. 10. In particular, embodiments may operate with software, hardware, and/or operating system implementations other than those described herein.

It is to be appreciated that the Detailed Description section, and not the Summary and Abstract sections (if any), is intended to be used to interpret the claims. The Summary and Abstract sections (if any) may set forth one or more but not all exemplary embodiments as contemplated by the inventor(s), and thus, are not intended to limit the disclosure or the appended claims in any way.

While the disclosure has been described herein with reference to exemplary embodiments for exemplary fields and applications, it should be understood that the disclosure is not limited thereto. Other embodiments and modifications thereto are possible, and are within the scope and spirit of the disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope should not be limited by any of the above-described exemplary embodiments, but should be defined only in accordance with the following claims and their equivalents.

What is claimed is:

1. A method, comprising:
generating a data structure containing a first predicate chosen from among a plurality of predicates;
distributing the data structure to a plurality of nodes in a distributed computing system;
receiving result fragments from one or more of the plurality of nodes; and
generating a merged result by combining the received result fragments.

2. The method of claim 1, wherein each of the plurality of nodes is configured to execute the data structure with respect to a portion of a database table.

3. The method of claim 1, further comprising determining not to combine a second predicate, from among the plurality of predicates, with the first predicate in the data structure.

4. The method of claim 3, further comprising generating an additional data structure containing the second predicate.

5. The method of claim 4, further comprising distributing the additional data structure to the plurality of nodes.

6. The method of claim 5, further comprising receiving one or more additional result fragments from the plurality of nodes.

7. The method of claim 6, wherein generating the merged result further comprises combining the one or more additional result fragments with the received result fragments.

8. The method of claim 1, wherein receiving the result fragments comprises receiving one or more bitmap fragments.

9. The method of claim 1, further comprising determining a set of predicates from among the plurality of predicates that should not be combined with other predicates.

10. The method of claim 1 wherein the result of the first predicate is dependent upon the result of a second predicate that is not part contained in the data structure.

11. A system, comprising:
a plurality of nodes; and
a controller configured to:
generate a data structure containing a first predicate chosen from among a plurality of predicates;
distribute the data structure to a plurality of nodes in a distributed computing system;
receive result fragments from one or more of the plurality of nodes; and
generate a merged result by combining the received result fragments.

12. The system of claim 11, wherein each of the plurality of nodes is configured to execute the first predicate with respect to a portion of a database.

13. The system of claim 11, wherein the controller is further configured to determine not to combine a second predicate, from among the plurality of predicates, with the first predicate.

14. The system of claim 13, wherein the controller is further configured to generate an additional data structure containing the second predicate.

15. The system of claim 14, wherein the controller is further configured to distribute the additional data structure to the plurality of nodes.

16. The system of claim 15, wherein the controller is further configured to receive one or more additional result fragments from the plurality of nodes.

17. The system of claim 16, wherein the controller is further configured to generate the merged result by combining the one or more additional result fragments with the received result fragments.

18. The system of claim 11, wherein the controller is further configured to receive the result fragments by receiving one or more bitmap fragments.

19. The system of claim 11, wherein the controller is farther configured to determine a set of predicates from among the plurality of predicates that should not be combined with other predicates.

20. A non-transitory computer-readable medium including computer instructions that, when executed by one or more computers, cause the one or more computers to perform the instructions, the instructions comprising instructions to:
generate a data structure containing a first predicate chosen from among a plurality of predicates;
distribute the data structure to a plurality of nodes in a distributed computing system;
receive result fragments from one or more of the plurality of nodes; and
generate a merged result by combining the received result fragments.
